(19) United States
(12) Patent Application Publication
(10) Pub. No.: US 2008/0060203 A1
(43) Pub. Date: Mar. 13, 2008

(54) TUBING CUTTER PLIERS

(75) Inventor: Michael D. METCALF, Colorado Springs, CO (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/530,929

(22) Filed: Sep. 12, 2006

(51) Int. Cl. B23D 21/06

(52) U.S. Cl. 30/101; 30/96

(57) ABSTRACT

The present disclosure provides an apparatus and method of combining pliers and tubing cutters. The resulting tools offers synergistic results that are unachievable with separate tools. In at least one embodiment, the tubing cutter pliers can be operated by rotating the pliers' handles, cutting the tubing with a cutter wheel on the pliers, and gripping the tubing using the same pliers as was used to cut the tubing. Some intervening steps, particularly, removal of the tubing cutter and replacement of the tubing cutter with pliers, can be eliminated with a resultant increase in efficiency and productivity. In some embodiments, an adjusting mechanism can be provided to offer increased control over the amount of pressure exerted on the tubing by the tubing cutter pliers during the cutting process.

### CROSS REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

The invention relates to hand tools. More specifically, the invention relates to pliers.

2. Description of Related Art

Pliers generally include a pair of handles attached to a pair of jaws with serrated teeth for gripping tubing, pipe, conduit, bolts, nuts, and other items therebetween. Typical pliers are slip joint, arc joint, long nose, self-adjusting, and other configurations. A tradesman or other person will have a wide variety of such pliers for performing various projects, often carrying large tool chests or tool belts to the projects. Other tools are often needed to complete the projects, including for example, tubing cutters of various shapes and sizes if working on tubing and conduit. A typical tubing cutter includes a set of rollers on one side of an adjustable opening and a cutter wheel on the other side of the opening. A section of tubing is inserted in the opening, the opening is closed over the tubing, and the tubing cutter is rotated around the tubing. Pressure on the cutter wheel is progressively increased, so that it progressively cuts through the tubing during the rotation, while the rollers maintain alignment between the tubing and the tubing cutter. Tubing cutters vary in shapes and sizes. A standard tubing cutter resembles a “C” clamp with a knob on a portion of the “C” to turn and progressively increase the pressure of the cutter wheel against the tubing. While generally not commercially available, some patents teach attaching the rollers and cutter wheel to a pair of handles to squeeze the rollers and cutter wheel around the tubing. Such patents include U.S. Pat. No. 6,751,867, U.S. Pat. No. 5,581,886, U.S. Pat. No. 5,475,924, and U.S. Pat. No. 4,858,316, the teachings of which are incorporated herein by reference.

Because time and efficiency reward the person performing the tasks, it is motivating to have the tools organized for easy access. A misplaced or even lost tool frequently causes loss of productivity. Thus, it would be advantageous to combine various tools where practical and feasible. While some teaching exist for modifying a standard “C” clamp tubing cutter to a pair of handles, no known teaching combines a pliers' function and structure of gripping surfaces with a tubing cutter. Even though such combinations may appear to be small improvements to some individuals, such combinations are nevertheless not existent in the art, offer new and inventive aspects to a mature art, and can be valuable commercially.

Thus, there remains a need for combining pliers and tubing cutters to form an entirely different paradigm to the use of both types of tools.

### BRIEF SUMMARY

The present disclosure provides an apparatus and method of combining pliers and tubing cutters. The resulting tools offers synergistic results that are unachievable with separate tools. In at least one embodiment, the tubing cutter pliers can be operated by rotating the pliers' handles, cutting the tubing with a cutter wheel on the pliers, and gripping the tubing using the same pliers as was used to cut the tubing. In some embodiments, intervening steps, particularly, removal of the tubing cutter and replacement of the tubing cutter with pliers, can be eliminated with a resultant increase in efficiency and productivity. Further, in some embodiments, an adjusting mechanism can be provided to offer increased control over the amount of pressure exerted on the tubing by the tubing cutter pliers during the cutting process.

The disclosure provides a tubing cutter pliers, comprising: a first handle coupled to a first jaw, the first jaw having a gripping surface; a second handle coupled to a second jaw, the second jaw having a gripping surface, and the second handle being rotatably coupled to the first handle so that an object can be held between the first and second jaws; and at least one tubing cutter coupled to at least one of the jaws.

The disclosure also provides a method of cutting and gripping a tubing, comprising: placing a pliers having a tubing cutter and jaws over the tubing; cutting the tubing with a tubing cutter on the pliers; and gripping the tubing with gripping surfaces on the jaws of the pliers.

### BRIEF DESCRIPTION OF THE DRAWINGS

While the concepts provided herein are susceptible to various modifications and alternative forms, only a few specific embodiments have been shown by way of example in the drawings and are described in detail below. The figures and detailed descriptions of these specific embodiments are not intended to limit the breadth or scope of the concepts or the appended claims in any manner. Rather, the figures and detailed written descriptions are provided to illustrate the concepts to a person of ordinary skill in the art as required by 35 U.S.C. § 112.

FIG. 1 is a perspective schematic diagram of at least one embodiment of a tubing cutter pliers.

FIG. 2 is a schematic side view of a variation of the tubing cutter pliers of FIG. 1.

FIG. 3 is a front perspective sectional view through jaw portions of the tubing cutter pliers of FIG. 1.

FIG. 4 is a top perspective schematic view of the tubing cutter pliers of FIG. 1 in the direction of a lower jaw and the cutter wheel.

### DETAILED DESCRIPTION

One or more illustrative embodiments of the concepts disclosed herein are presented below. Not all features of an actual implementation are described or shown in this application for the sake of clarity. It is understood that the development of an actual embodiment, numerous implementation-specific decisions must be made to achieve the developer's goals, such as compliance with system-related, business-related and other constraints, which vary by implementation and from time to time. While a developer's efforts might be complex and time-consuming, such efforts would be, nevertheless, a routine undertaking for those of ordinary skill in the art having benefit of this disclosure.

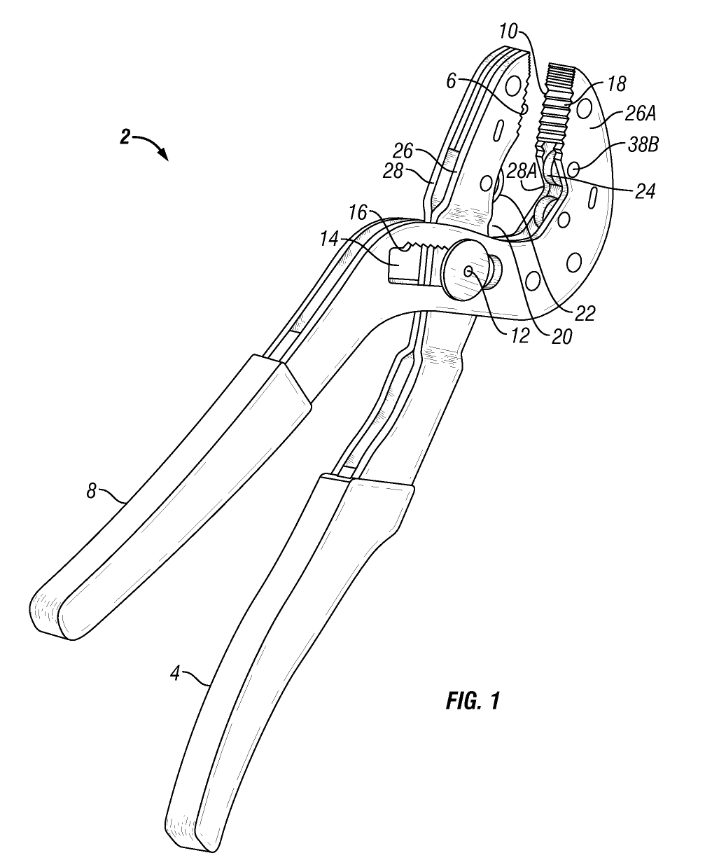

FIG. 1 is a perspective schematic diagram of at least one embodiment of a tubing cutter pliers. A tubing cutter pliers 2 generally includes a first handle 4 coupled with a first jaw 6 and a second handle 8 coupled with a second jaw 10. The handles are rotatably coupled to each other about a pivot element 12 so that manipulation of the handles causes a change in spacing between the first and second jaws. In some embodiments, the tubing cutter pliers can include an adjustable initial height between the jaws for greater flexibility in the use of the pliers. In such embodiments, a spacing slot 14 can be provided in which the pivot element 12 can move in a translating direction up and down the slot relative to the other handle and jaw. Once the proper spacing is selected or otherwise reached, the pivot element 12 can engage the other corresponding handle and jaw by use of various elements known in the art. These include, for example, spacing elements 16, such as teeth, ridges, slots, and other adjustable joints as may be found, for example, in self-adjusting pliers, arc joint pliers, slip joint pliers, long nose pliers, and other types of pliers known in the art with this particular feature.

The jaws generally include a gripping surface which can be smooth or have a particular shape to assist in holding an element therebetween. For example, one or more of the jaws 6, 10, can include gripping teeth 18 which may be particularly useful for circular or rounded elements disposed therebetween. The junction between the jaws 6, 10 adjacent the pivot element 12 forms a throat 20. The throat 20, as explained below, is conducive in at least one embodiment for placing the tubing cutter assembly of the tubing cutter pliers. Thus, the jaws 6, 10 would extend distally from the pivot element 12 relative to the tubing cutter assembly in at least some embodiments. In other embodiments, the orientation could be reversed, so that the tubing cutter assembly is distal from the throat relative to the jaws. Further, the tubing cutter assembly can be on an opposite side of the pivot element 12 relative to the jaws.

The tubing cutting elements generally include at least a cutter wheel 22 described in more detail below and shown particularly in FIG. 4. Further, in at least some embodiments, the tubing cutter assembly can include one or more tubing rollers 24. The tubing rollers 24 can assist in maintaining alignment with the cutter wheel 22 as the tubing cutter pliers 2 and a tubing is rotated relative thereto. Generally, the cutter wheel 22 includes a circular, relatively sharp surface that can shear with sufficient pressure a tubing placed adjacent thereto. The term “tubing” is used broadly herein and is intended to include any generally circular element that can be typically cut by a tubing cutter, and specifically includes tubing, pipe, conduit, and some bolts, and even bars. Additionally, the tubing cutter assembly can include one or more tubing rollers 24. The tubing roller is generally a circular element that has a flatter surface than the cutter wheel 22. The tubing roller 24 can act as a bearing surface about which the tubing can rotate as the tubing is being cut by the cutter wheel 22.

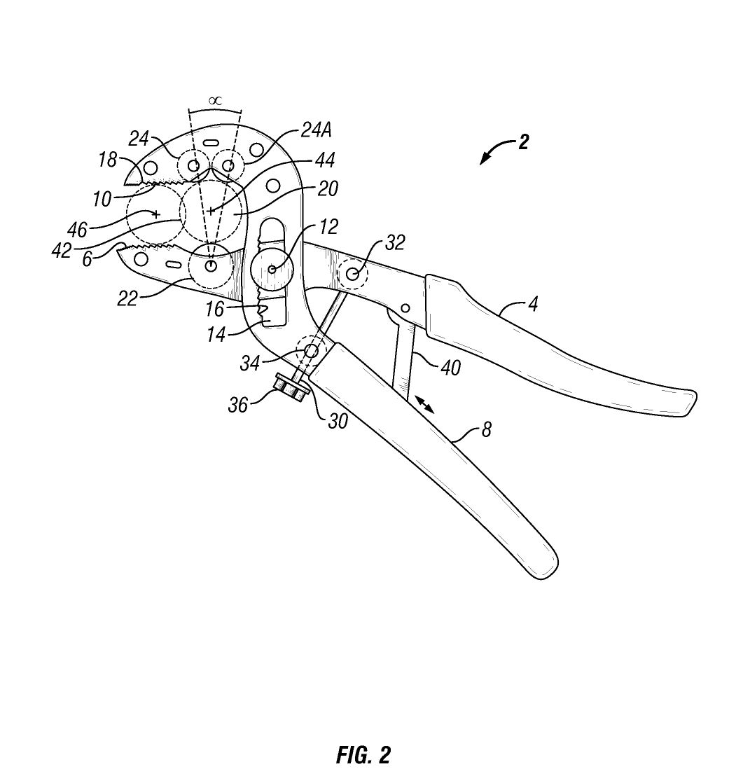

FIG. 2 is a schematic side view of a variation of the tubing cutter pliers of FIG. 1. Similar elements described in FIG. 1 are similarly numbered. For illustrative purposes, a tubing 42 is shown drawn at a first location designated as a cutting position 44, and at a second location designated as a gripping position 46 between the gripping surfaces of the jaws 6, 10. The cutting position 44 is generally between the cutter wheel 22 and the tubing roller 24. In the embodiment shown in FIG. 2, the cutting position 44 would generally be in the throat 20. To help maintain alignment of the tubing 42 in the cutting position 44 when disposed between the cutter wheel 22 and the tubing roller 24, an additional tubing roller 24a can be coupled to the tubing cutter pliers. Generally, the tubing roller 24 and tubing roller 24a will be disposed at an angular distance away from each other, such as angle “α”, where the angle would originate in the center point of the cutter wheel 22 as shown. Thus, a tubing 42 disposed between the cutter wheel 22 and the tubing rollers 24, 24a forms a triad which helps maintain the position of the tubing 42 to be cut therebetween.

Advantageously and uniquely, the tubing cutter pliers 2 can cut the tubing 42 between the cutter wheel 22 and the tubing rollers 24, 24a. Either prior to cutting or after cutting, the tubing 42 can be relocated along the jaws 6, 10 for gripping and handling of the tubing therebetween without necessitating another pair of pliers to grip the tubing. In some embodiments, the repositioning can occur without the tubing cutter pliers having to be removed from the tubing. Thus, the steps can be combined within one tool for both cutting and gripping the tubing.

In at least one method of use, a tubing can be placed between the jaws 6, 10 at the gripping position 46, and gripped, turned, or otherwise manipulated, if necessary. The tubing can simply be located within the throat 20 and the handles compressed either by squeezing the handles or by using an adjustable element 30, if provided, to cut tubing between the cutter wheel 22 and the tubing rollers 24, 24a. The tubing can be located to the gripping position 46 between the jaws 6, 10 for other or further manipulation. Variations of the sequence can naturally be made, such as cutting first, cutting last, not gripping in particular cases, or not cutting and only gripping. The flexibility of the present invention allows the operator to make such choices with a single tool that is heretofore not been possible.

The particular embodiment of the tubing cutter pliers shown in FIG. 2 can include a self-adjusting feature 40. The self-adjusting bar 40 pivots longitudinally along the first handle 4 and is spring biased in position on the second handle 8. When starting to grasp a tubing 42 between the jaws and squeezing the first and second handles 4, 8 together, the jaws initially move closer to each other, moving the pivot element 12 to a different translated position in the spacing slot 14. Upon contact of the jaws with the tubing 42 or other element disposed therebetween and continued squeezing of the handles 4, 8, the self-adjusting bar 40 slides longitudinally down the handle 8. The translated movement of the self-adjusting bar 40 then allows the pivot element 12 to engage the spacing element 16 in the slot 14 and lock the pivot element 12 in a particular translated position, so that the pliers' jaws can rotate thereafter in a conventional manner. The self-adjusting feature is known in the art and is covered, for example, by U.S. Pat. No. 4,651,598 and other similar patents, and is incorporated herein by reference. Other tubing cutter pliers may not have the self-adjusting feature and such features are described only for clarity and to include such exemplary pliers within the scope of the claims that follow.

Generally, the handles 4, 8 can be squeezed together and the pliers rotated about the tubing 42 to be cut. Alternatively, the tubing can be rotated within the pliers. It may be advantageous to include an additional feature to help maintain a steady amount of pressure on the tubing cutter while cutting the tubing. An adjustable element 30 can be used to increase the cutting pressure on the tubing 42 to cut in a more controlled manner. In at least one embodiment, the adjustable element 30 can include a threaded rod that can be rotated so that the relative distance between the first handle 4 and the second handle 8 and therefore the jaws 6, 10 can be moved in a controlled fashion. For example and without limitation, the adjustable element 30 can be pivotally coupled to the first handle 4 at a first pivot 32, and be pivotally and treadably coupled to the second handle 8 at a second pivot 34. Further, the adjustable element 30 can include an adjuster 36, such as a thumbwheel or other conveniently accessed element. Thus, the adjuster 36 could be rotated conveniently by hand pressure, so that the relative distance between the first handle 4 and the second handle 8 is decreased. The decreased distance between the handles causes the cutter wheel 22 to more firmly engage the tubing disposed therebetween. As the pliers are rotated relative to the tubing or vice versa, the cutter wheel engages the outer surfaces of the tubing and eventually cuts through the tubing. After cutting is complete, the adjuster 36 can be rotated in the opposite direction to release the pliers to operate in a more conventional manner.

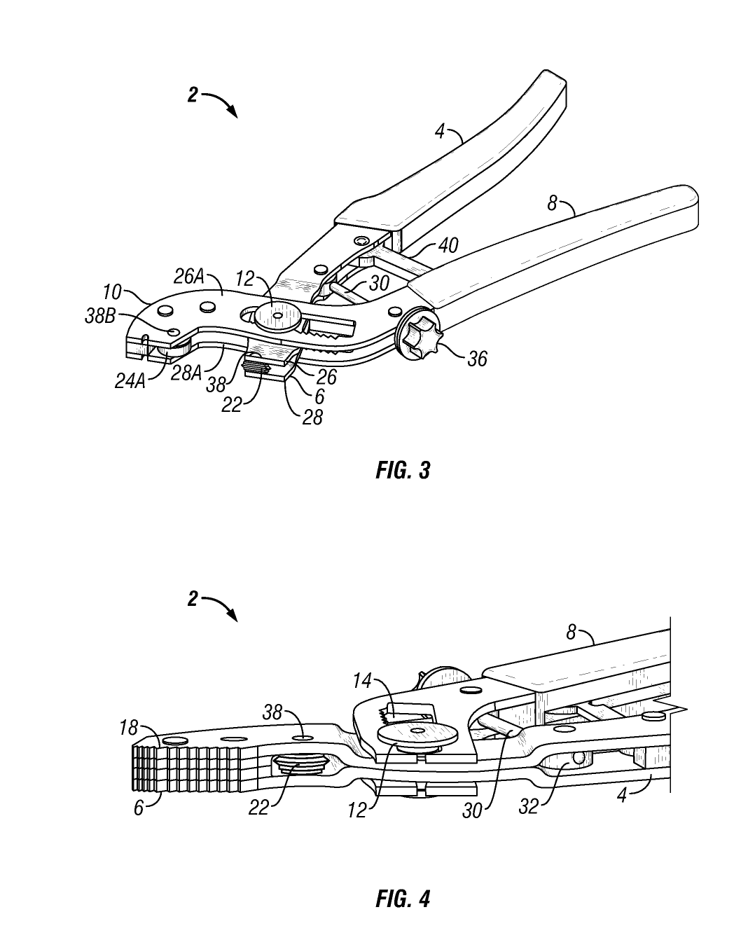

FIG. 3 is a front perspective sectional view through jaw portions of the tubing cutter pliers of FIG. 1. FIG. 3 illustrates elements described above in FIGS. 1 and 2 and the numbering will be consistent therewith. The sectional portion of FIG. 3 is cut through the second jaw 10 between the tubing roller 24 and tubing roller 24a and through a sectional portion of the cutter wheel 22 disposed on the first jaw 6. In at least one embodiment, the relatively flatter surface of the roller 24a is illustrated compared to the relatively narrower and sharper cutting surface of the cutter wheel 22. Also illustrated in FIG. 3 is an exemplary embodiment of one or more of the tubing handles 4, 8. For example, the first handle 4 can include a first side 26 and a second side 28. Similarly, the second handle 8 can include a first side 26a and a second side 28a. The various elements described herein can be located between the first sides 26, 26a and second sides 28, 28a, including the adjustable element 30, the self-adjusting bar 40, and the various pivotal joints associated therewith. Further, tubing roller 24a and the cutter wheel 22 can be disposed between the first sides 26, 26a and second sides 28, 28a of the respective tubing handles 4, 8. Other embodiments are possible, including cantilevered connections that extend outward from one or more of the sides. Thus, the embodiment shown is not to be restricted to the particular method of connecting the various joints. For example, the pliers could include a solid jaw without the separate laminar pieces.

Further, the elements can be coupled to the handles, jaws, or a combination thereof by various fasteners such as pins, rivots, screws and other known fastening elements. For example, the cutter wheel 22 can be coupled to the first jaw 6 with a fastener 38. Likewise, the tubing roller 24a can be coupled to the second jaw 10 with a fastener 38b.

FIG. 4 is a top perspective schematic view of the tubing cutter pliers of FIG. 1 in the direction of a lower jaw and the cutter wheel. Looking down on the first handle 4 from FIG. 2, the first handle 4 is shown coupled to the first jaw 6. In at least some embodiments, the jaw 6 can include gripping teeth 18 although the gripping surfaces of the jaw 6 could be flat, rounded, or otherwise as may be appropriate for the particular use of the tubing cutter pliers 2. The cutter wheel 22 can be coupled to the first jaw 6 with a fastener 38. The pivot element 12 can be coupled to the first handle 4 to rotate within the spacing slot 14 as described above. The adjustable element 30 is also shown pivotally coupled to the first handle 4 at a first pivot 32, if the tubing cutter pliers 2 includes such feature.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. The term “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include without limitation integrally forming one functional member with another in a unity fashion. The coupling can occur in any direction, including rotationally. Unless the context requires otherwise, the word “comprise” or variations such as “comprises” or “comprising ”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

The invention has been described in the context of various embodiments and not every embodiment of the invention has been described. Apparent modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect all such modifications and improvements to the full extent that such falls within the scope or range of equivalent of the following claims.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant.

1. A tubing cutter pliers, comprising:
a first handle coupled to a first jaw, the first jaw having a gripping surface;
a second handle coupled to a second jaw, the second jaw having a gripping surface, and the second handle being rotatably coupled to the first handle so that an object can be held between the first and second jaws; and
at least one cutter wheel coupled to at least one of the jaws.

2. The pliers of claim 1, further comprising at least one cutter roller coupled to a jaw opposite from the jaw to which the cutter wheel is coupled.

3. The pliers of claim 2, further comprising at least two cutter rollers coupled to the opposite jaw and spaced at an angle to each other relative to the cutter wheel.

4. The pliers of claim 1, wherein the cutter wheel is coupled to the jaw at a location adjacent an intersection of the first and second handles.

5. The pliers of claim 1, wherein at least one of the jaws comprises gripping teeth.

6. The pliers of claim 1, further comprising a manually adjustable element coupling the first and second jaws to manually adjust a spacing between the cutter wheel and the jaw opposite from the cutter wheel.

7. The pliers of claim 6, wherein the manually adjustable element comprises a rotatable threaded element adapted to space the first jaw from the second jaw when the cutter wheel is placed in proximity to a tubing to be cut.

8. The pliers of claim 1, wherein the pliers comprises self-adjusting pliers, arc joint pliers, slip joint pliers, and long nose types of pliers having the cutter wheel coupled thereto.

9. The pliers of claim 1, wherein the cutter wheel is adapted to engage a tubing disposed adjacent thereto by movement of at least one of the jaws.

10. A method of cutting and gripping a tubing, comprising:
placing a pliers having a cutter wheel and jaws over the tubing;
cutting the tubing with a cutter wheel on the pliers; and
gripping the tubing with gripping surfaces on the jaws of the pliers.

11. The method of claim 10, wherein cutting the tubing with the cutter wheel on the pliers comprises moving the jaws to cause the cutter wheel to engage the tubing and rotating the pliers relative to the tubing to cut the tubing.

12. The method of claim 11, further comprising moving the jaws to position the tubing away from the cutter wheel and moving the jaws in an opposite direction to grip the tubing between the jaws without engaging the tubing with the cutter wheel.

13. The method of claim 10, further comprising manually adjusting a spacing of the jaws by rotating a threaded element coupled between the jaws.

14. The method of claim 13, wherein the rotating the threaded element comprises adjusting a spacing of the cutter wheel.
